(19) United States
(12) Patent Application Publication
(10) Pub. No.: US 2016/0332269 A1
(43) Pub. Date: Nov. 17, 2016

(54) COLD FORMED SUPPORT BLOCK AND METHOD OF MAKING THE SAME

(71) Applicant: Kennametal Inc., Latrobe, PA (US)

(72) Inventors: Beth A. Provins, Arnold, PA (US); Eric P. Helsel, New Enterprise, PA (US); Brian K. Lavely, Ebensburg, PA (US); William P. Prezlock, Bedford, PA (US); Luke A. Weber, Bedford, PA (US)

(21) Appl. No.: 14/708,488

(22) Filed: May 11, 2015

(51) Int. Cl. B23P 15/28; E21C 35/19; E01C 23/12; E21C 25/10

(52) U.S. Cl. CPC B23P 15/28; E21C 25/10; E21C 35/19; E01C 23/12

(57) ABSTRACT

A support block adapted for attachment to a surface of a rotatable driving member of a cutting tool machine and adapted for receiving a cutting tool includes a cold formed support block body that includes an axial rearward end having a mounting portion for attachment to the surface of the rotatable driving member and an axial forward end having a front surface. The support block also includes a bore defined by the front surface that is configured for receiving the cutting tool. A method of making the support block is also provided.

### BACKGROUND OF THE INVENTION

The invention pertains generally to a cutting bit or cutting tool assembly or machine that is useful in association with machines for impinging a substrate or earth strata such as, for example, asphaltic roadway material, coal deposits, mineral formations and the like. More particularly, the invention pertains to a support block for a cutting bit or cutting tool assembly and a method of making the same.

One typically uses such a cutting bit or cutting tool assembly in conjunction with a rotatable drum or driven member. The driven member rotates in such a fashion to drive a cutting bit or cutting tool into earth strata to disintegrate the same into smaller pieces including fine particulates, i.e., cutting debris. Such an assembly has application in a number of specific environments. One specific environment is mining as a component of a mining machine. Another specific environment is road construction as a component of a road planing machine or a road milling machine.

Mining machines and construction machines (e.g., a road planing machine or road milling machine) are useful in continuous mining or road milling applications to mine or mill earth strata such as, for example, coal, asphalt, concrete and the like. These mining machines and construction machines utilize cutting bit or cutting tool assemblies. Each cutting bit or cutting tool assembly for continuous mining or road milling applications typically comprises a cutting bit rotatably or non-rotatably mounted within a support block or base. In turn, the support block mounts, typically by welding, on a drum or other body, wherein a suitable power source (or means) drives the drum. Other components may also be used in association with the cutting bit and support block, such as, for example, tool holders, wear sleeves, etc.

During operation of the mining or construction machine, the support block experiences wear due to exposure thereof to the cutting debris. Over time, wear, cyclic loading fatigue and other kinds of abuse causes the support block to become ineffective which signals an end to its useful life. Once this occurs, the operator must cut or torch the support block off the drum to allow for replacement of the support block. Typically, the operator welds the replacement support block on the drum. As the skilled artisan appreciates, it is time-consuming, and hence costly, to remove and replace a support block. Thus, there is an advantage to be able to prolong the useful life of the support block, as well as, to reduce the cost of original or replacement support blocks.

Heretofore, support blocks have been manufactured using hot forming or hot working methods or casting. Hot methods often involve multiple steps and pieces of forming or working equipment and typically involve post forming or working processing steps. In addition, hot methods typically result in a large amount of raw material being wasted. In addition, castings typically result in a variety of inherent imperfections that reduce strength.

Thus, it would be highly desirable to provide an improved cutting tool assembly relating to the type described herein that overcomes disadvantages and shortcomings of heretofore known such assemblies. It would also be highly desirable to provide an improved support block or base for such cutting tool assemblies relating to the type described herein that overcomes disadvantages and shortcomings of heretofore known support blocks or bases for such assemblies. In addition, it would be advantageous to provide a support block or base for such assemblies that involve reduced processing steps and/or less expensive manufacturing methods. In addition, it would be advantageous to provide a support block or base for such assemblies that reduces the amount of raw material necessary to make the support block or base.

### SUMMARY OF THE INVENTION

In accordance with an aspect of the invention, a method of making a support block adapted for attachment to a surface of a rotatable driving member of a cutting tool machine and adapted for receiving a cutting tool includes: providing a stock material; cold forming the stock material to make the support block to include an axial rearward end having a mounting portion for attachment to the surface of the rotatable driving member; cold forming the stock material to make the support block to also include an axial forward end having a front surface; and forming a bore in the front surface that is configured for receiving the cutting tool.

In accordance with another aspect of the invention, a method of making a support block adapted for attachment to a surface of a rotatable driving member of a cutting tool machine and adapted for receiving a cutting tool includes providing a stock material and cold forming the stock material to make the support block.

In accordance with another aspect of the invention, a support block adapted for attachment to a surface of a rotatable driving member of a cutting tool machine and adapted for receiving a cutting tool includes a cold formed support block body that includes an axial rearward end having a mounting portion for attachment to the surface of the rotatable driving member and an axial forward end having a front surface. The support block also includes a bore defined by the front surface that is configured for receiving the cutting tool.

These and other aspects of the present invention will be more fully understood following a review of this specification and drawings.

### BRIEF DESCRIPTION OF THE DRAWINGS

FIG. 1 is a side view of a cutting tool assembly, in accordance with an aspect of the invention.

FIG. 2 is an isometric view of a support block, in accordance with an aspect of the invention.

FIG. 3 is a side view of the support block of FIG. 2, in accordance with an aspect of the invention.

FIG. 4 is a top view of the support block of FIG. 2, in accordance with another aspect of the invention.

FIG. 5 is a bottom view of the support block of FIG. 2, in accordance with an aspect of the invention.

FIGS. 6a-6e are microstructure sectional views of the support block taken along line 6-6 of FIG. 4 wherein FIG. 6a is adjacent the top of the support block, FIG. 6b is adjacent the bottom of the support block and FIGS. 6c-6e are along the middle of the support block, in accordance with an aspect of the invention.

FIGS. 7a-7e are microstructure sectional views of a prior art hot formed support block taken along a similar line as FIGS. 6a-6e.

### DETAILED DESCRIPTION

The following description is for purposes of illustrating various aspects of the invention only and not for purposes of limiting the scope of the invention.

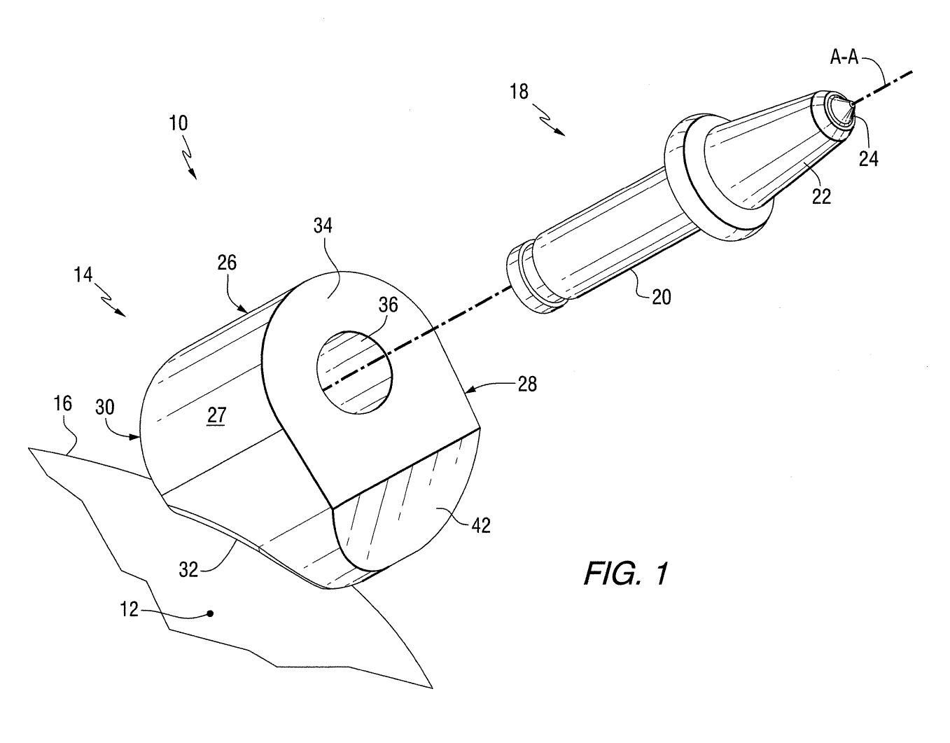

FIG. 1 is a side view of a cutting bit or cutting tool assembly or machine, generally designated as reference number 10, in accordance with various aspects of the invention. It will be appreciated that the invention has application to various kinds of cutting tools useful in various kinds of cutting operations. Exemplary operations include, without limitation, road planing (or milling), coal mining, concrete cutting, and other kinds of cutting operations wherein a cutting tool with a hard cutting member impinges against a substrate (e.g., earth strata, pavement, asphaltic highway material, concrete, minerals and the like) breaking the substrate into pieces of a variety of sizes including larger-size pieces or chunks and smaller-sized pieces including dust-like particles. In addition, it will be appreciated that the assembly 10 of the invention, and components thereof, may be manufactured in various sizes and dimensions depending upon the desired application of the assembly 10.

Specifically, FIG. 1 illustrates a portion of a rotatable drum 12 (i.e., a rotatable driving member), which could be used, for example, in a mining machine or a road milling machine. A mounting assembly 14 is adapted for attachment to a surface 16 of the rotatable driving member 12 of the cutting tool assembly 10 and is further adapted for receiving a cutting bit or cutting tool 18. Typically, the cutting tool 18 is a rotatable cutting tool with a shank portion 20 and a head portion 22 having a hard cutting member 24 extending along a longitudinal axis A-A for impinging against a substrate, e.g., earth strata, pavement, asphaltic highway material, concrete, minerals and the like as is well known in the art.

In accordance with an aspect of the invention, the mounting assembly 14 includes a base or support block 26. It will be appreciated that other components may also be used in association with the mounting assembly 14 and/or the cutting tool 18 and/or the support block 26, such as, for example, tool holders, wear sleeves, etc.

In one aspect, the support block 26 includes a support block body 27 having an axial forward end 28 and an axial rearward end 30. The support block body 27 includes at the axial rearward end 30 thereof a mounting portion 32 for attachment to the surface 16 of the rotatable driving member 12. The support block body 27 also includes a front portion or front surface 34 that defines a bore 36 that is generally configured for receiving the cutting tool 18.

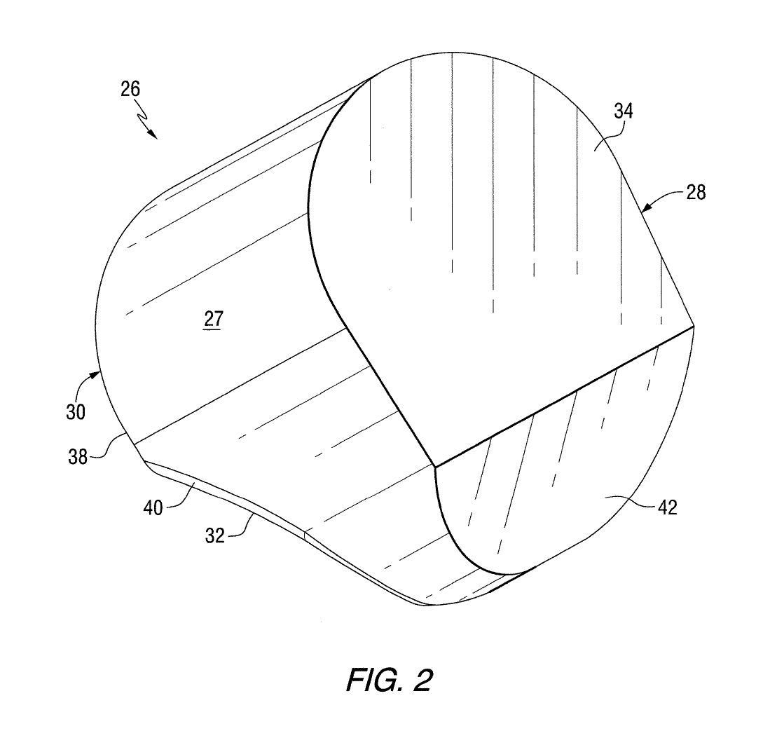

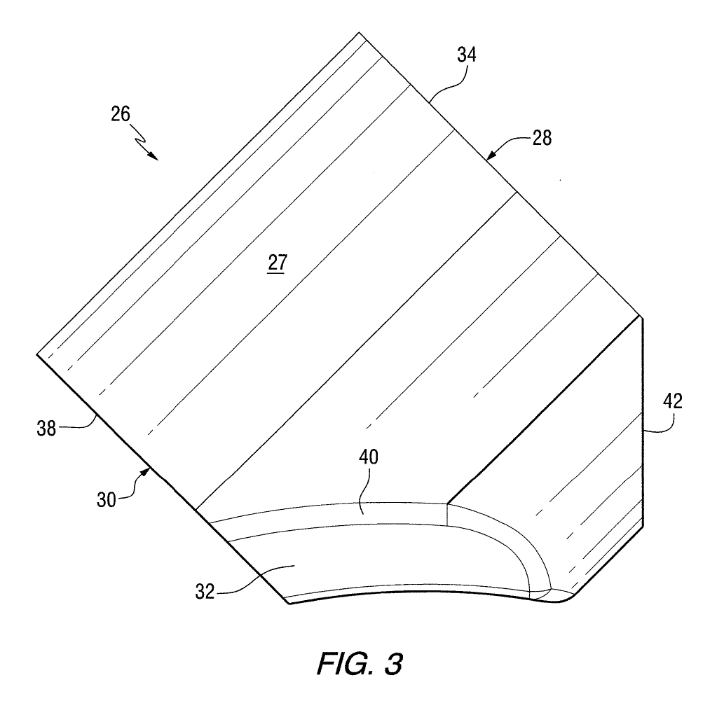

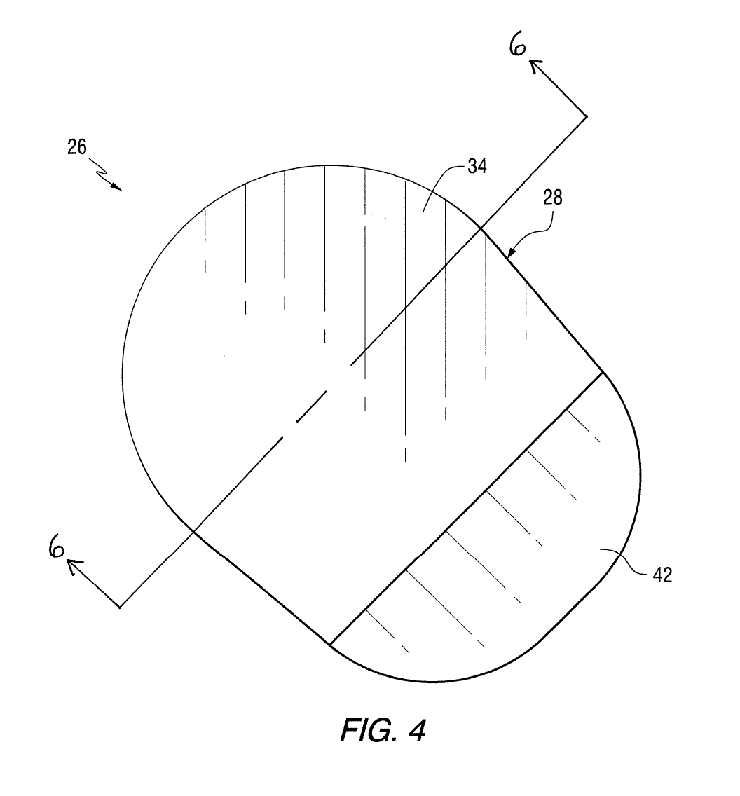

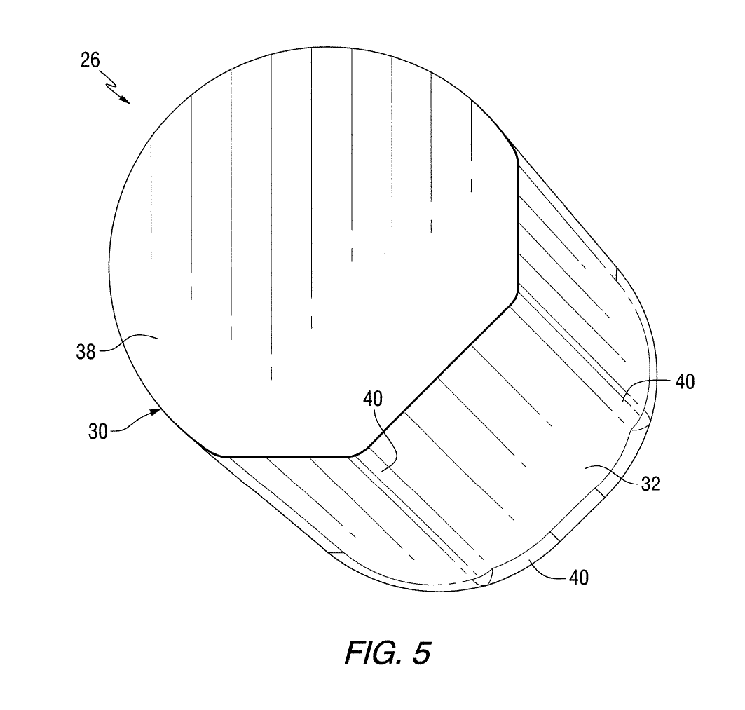

Referring to FIGS. 2-5, there is illustrated the support block 26 as made or manufactured by cold forming and prior to the bore 36 being formed therein, in accordance with an aspect of the invention.

More particularly, the support block 26 is made or manufactured by providing a piece of stock material formed of, for example, steel or a like material, and cold forming the stock material to produce the support block 26. In one aspect, the stock material is cold formed to make the support block 26 to include the axial rearward end 30 having the mounting portion 32 for attachment to the surface 16 of the rotatable driving member 12. The stock material can also be cold formed to make the support block 26 such that the axial rearward end 30 also includes a bottom surface 38 adjacent to the mounting portion 32. The stock material can also be cold formed to make the support block 26 such that the axial rearward end 30 also includes a chamfer attachment area 40 adjacent at least a portion of a perimeter of the mounting portion 32. The chamfer attachment area 40 provides an area for an attachment means such as, for example, brazing or welds to be applied for attaching the support block 26 to the surface 16.

In another aspect, the stock material is cold formed to make the support block 26 to include the axial forward end 28 having the front surface 34. In one aspect, the front surface 34 is generally planar and the bottom surface 30 is generally planar with the front surface 34 and the bottom surface 30 being generally opposed to one another. The stock material can also be cold formed to make the support block 26 such that the axial forward end 28 also includes a sloped surface 42 adjacent the front surface 34. In one aspect, the sloped surface 42 is generally opposed to the mounting portion 32 and the sloped surface 42 generally slopes or slants away from the front surface 34 and toward the axial rearward end 30.

As described, the bore 36 is formed subsequent to the cold forming the stock material to make the support block 26 by, for example, known techniques such as drilling or boring through the support block body 27. In one aspect, the bore 36 extends from the front surface 34 to the bottom surface 38, i.e. completely through the support block body 27.

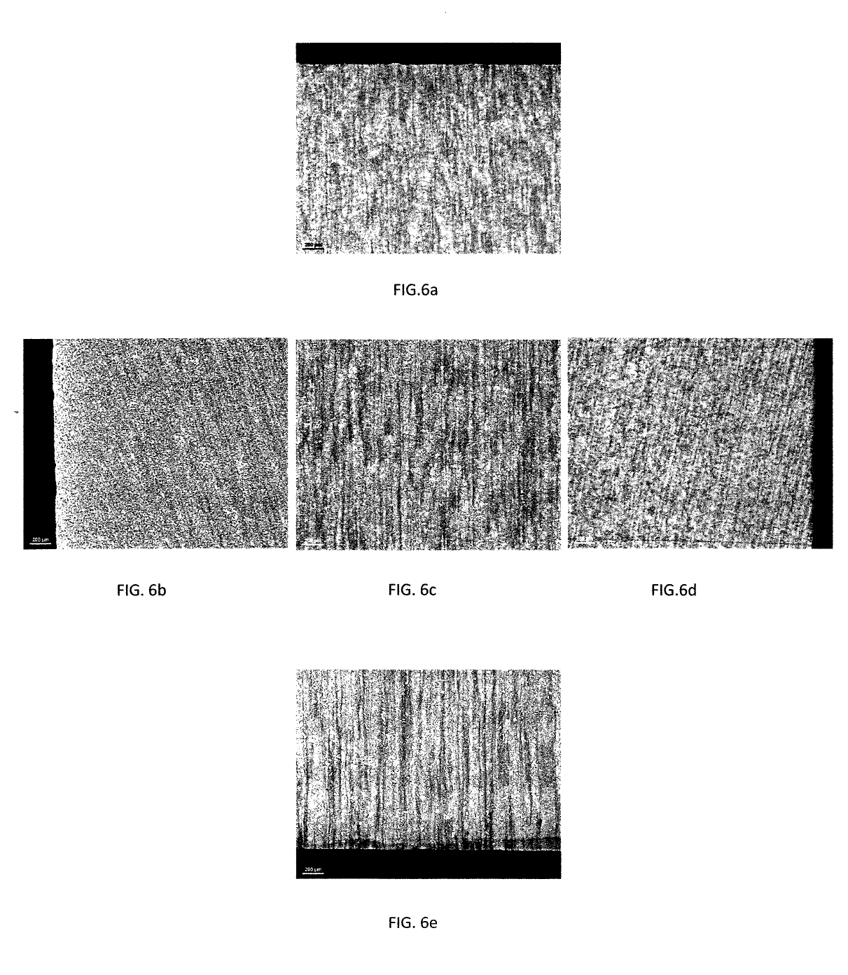

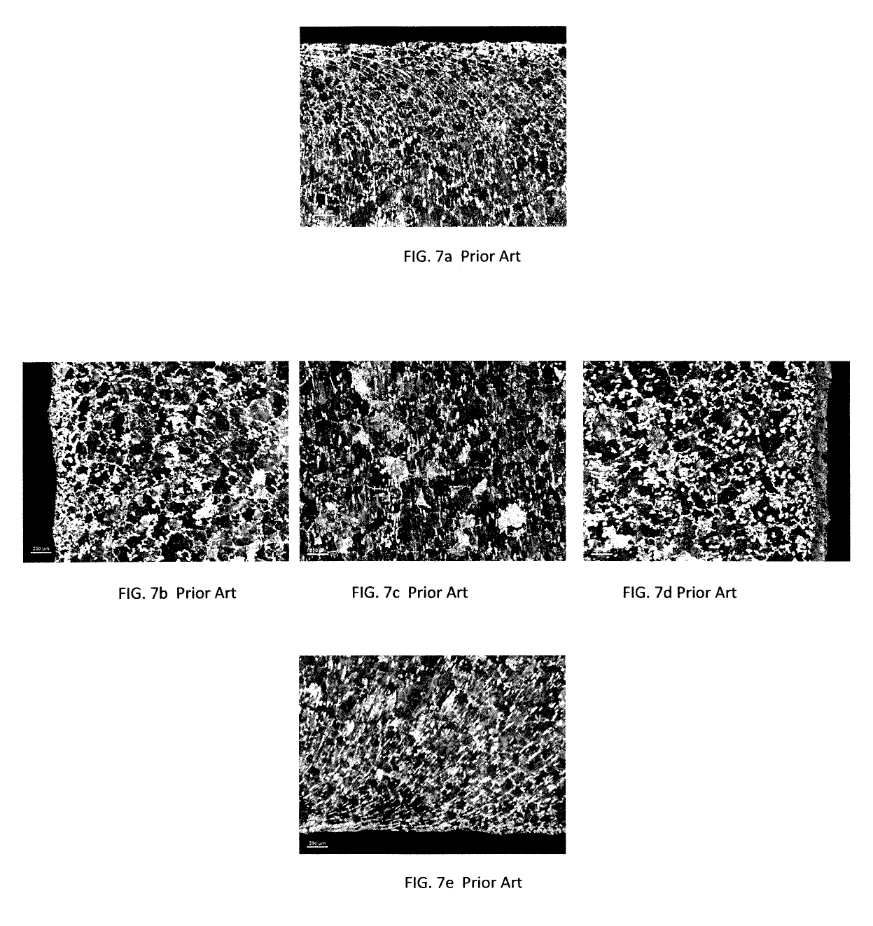

Referring to FIGS. 6a-6e, there is illustrated the microstructure of a cold formed support block, such as support block 26 described herein. Specifically, FIGS. 6a-6e show a uniform grain structure with little variation from outer surface to internal structure. Whereas a hot forged support block (see FIGS. 7a-7e) shows higher variation in the grain size with smaller particles near the surface and larger particles present closer to the internal section. The uniform structure provided by cold forging the support block will present better wear properties as it will be less susceptible to cracking or fracturing versus the larger grain structure of the hot forged block. Flow lines present in cold forged blocks are packed tightly together with less gap spacing differences as compared to the hot forged block. The tight packing observed within the cold forged block will provide a tougher structure that is better suited to handling shear stresses and lateral loading during operation.

In addition, it will be appreciated that the cold formed support block is stronger than the hot formed support block due to grain flow from cold forming. When cold formed instead of hot forged, the material consumption (waste) is reduced by, for example, about 26% because the hot forged part is trimmed post forming and the cold formed part does not require this operation. When compared to a cast part, the cold formed support block eliminates porosity and inclusions. In other aspects, cold forming the support block provides for more dimensional uniformity, improved welding/attachment area and improved symmetry in the center plane of the support block. Thus, the cold formed process makes a stronger support block with a tighter tolerance. In one aspect, this makes machining the support block easier and assembly of the drum easier.

As used herein, “cold forming” generally refers to mechanical operations such as, for example, bending, drawing, hammering, and/or rolling a metal shape into a new metal shape without need to add heat to the part being shaped.

Whereas particular aspects of this invention have been described above for purposes of illustration, it will be evident to those skilled in the art that numerous variations of the details of the present invention may be made without departing from the invention as defined in the appended claims.

What is claimed is:

1. A method of making a support block adapted for attachment to a surface of a rotatable driving member of a cutting tool machine and adapted for receiving a cutting tool, the method comprising:
providing a stock material;
cold forming the stock material to make the support block to include an axial rearward end having a mounting portion for attachment to the surface of the rotatable driving member;
cold forming the stock material to make the support block to also include an axial forward end having a front surface; and
forming a bore in the front surface that is configured for receiving the cutting tool.

2. The method of claim 1, further including cold forming the stock material to make the support block such that the axial rearward end also includes a chamfer attachment area adjacent at least a portion of a perimeter of the mounting portion.

3. The method of claim 2, further including cold forming the stock material to make the support block such that the axial rearward end also includes a bottom surface adjacent the mounting portion.

4. The method of claim 3, wherein the front surface is generally planar and the bottom surface is generally planar, the front surface and the bottom surface being generally opposed.

5. The method of claim 3, further including cold forming the stock material to make the support block such that the axial forward end also includes a sloped surface adjacent the front surface, wherein the sloped surface is generally opposed to the mounting portion and the sloped surface slopes away from the front surface and toward the axial rearward end.

6. The method of claim 3, further including providing the bore to extend from the front surface to the bottom surface.

7. The method of claim 1, wherein the bore is formed subsequent to the cold forming the stock material to make the support block.

8. A method of making a support block adapted for attachment to a surface of a rotatable driving member of a cutting tool machine and adapted for receiving a cutting tool, the method comprising:
providing a stock material; and
cold forming the stock material to make the support block.

9. The method of claim 8, including cold forming the stock material to make the support block to include an axial rearward end having a mounting portion for attachment to the surface of the rotatable driving member.

10. The method of claim 9, further including cold forming the stock material to make the support block such that the axial rearward end includes a chamfer attachment area adjacent at least a portion of a perimeter of the mounting portion.

11. The method of claim 10, further including cold forming the stock material to make the support block such that the axial rearward end also includes a bottom surface adjacent the mounting portion.

12. The method of claim 11, further including cold forming the stock material to make the support block to also include an axial forward end having a front surface generally opposed to the bottom surface.

13. The method of claim 12, wherein the front surface is generally planar and the bottom surface is generally planar.

14. The method of claim 12, further including cold forming the stock material to make the support block such that the axial forward end also includes a sloped surface adjacent the front surface, wherein the sloped surface is generally opposed to the mounting portion and the sloped surface slopes away from the front surface and toward the axial rearward end.

15. The method of claim 12, further including providing a bore in the front surface that is configured for receiving the cutting tool.

16. The method of claim 15, further including providing the bore to extend from the front surface to the bottom surface.

17. The method of claim 15, wherein the bore is formed subsequent to the cold forming the stock material to make the support block.

18. A support block adapted for attachment to a surface of a rotatable driving member of a cutting tool machine and adapted for receiving a cutting tool, the support block comprising:
a cold formed support block body that includes:
an axial rearward end having a mounting portion for attachment to the surface of the rotatable driving member;
an axial forward end having a front surface; and
a bore defined by the front surface that is configured for receiving the cutting tool.

19. The support block of claim 18, wherein the cold formed support block body further includes the axial rearward end also having a bottom surface adjacent the mounting portion.

20. The support block of claim 18, wherein the bore extends through the cold formed support block body from the front surface to the bottom surface.
